(19) United States
(12) Patent Application Publication
(10) Pub. No.: US 2025/0006970 A1
(43) Pub. Date: Jan. 2, 2025

(54) SYSTEM FOR PACKAGING A PLURALITY OF STACKS OF SOLID OXIDE CELLS OF HIGH-TEMPERATURE SOEC/SOFC TYPE

(71) Applicant: COMMISSARIAT A L'ENERGIE ATOMIQUE ET AUX ENERGIES ALTERNATIVES, Paris (FR)

(72) Inventors: Stéphane DI IORIO, Grenoble Cedex 09 (FR); Olivier GILLIA, Grenoble Cedex 09 (FR); Thibault MONNET, Grenoble Cedex 09 (FR); Karl VULLIEZ, Grenoble Cedex 09 (FR)

(73) Assignee: COMMISSARIAT A L'ENERGIE ATOMIQUE ET AUX ENERGIES ALTERNATIVES, Paris (FR)

(21) Appl. No.: 18/708,728

(22) PCT Filed: Nov. 21, 2022
(86) PCT No.: PCT/FR2022/052137

§ 371 Date: May 9, 2024

(30) Foreign Application Priority Data
Nov. 23, 2021 (FR) 2112366

(51) Int. Cl. H01M 8/248; C25B 9/65; C25B 9/77; C25B 13/05; H01M 8/12; H01M 8/2432; H01M 8/249

(52) U.S. Cl. CPC H01M 8/248; C25B 9/66; C25B 9/77; C25B 13/05; H01M 8/2432; H01M 8/249; H01M 8/12; H01M 2008/1293

(57) ABSTRACT

A system for conditioning a plurality of stacks of solid oxide cells of the SOEC/SOFC type, includes: a thermal enclosure delimiting an internal volume; a frame, positioned on either side of the thermal enclosure; a first crosspiece device, mounted on the frame in a movable manner relative thereto; a plurality of clamping rods, intended to contact the stacks to allow them to be clamped; a plurality of elastic return members fixed to a clamping rod and to the first crosspiece device such that each clamping rod is supported by an elastic return member capable of being compressed under the effect of the weight of the clamping rod.

### TECHNICAL FIELD

The present invention relates to the general field of High Temperature Electrolysis (HTE), in particular High Temperature Steam Electrolysis (HTSE), the electrolysis of carbon dioxide (CO₂), or else the co-electrolysis of steam and carbon dioxide (CO₂) at high temperature.

More specifically, the invention relates to the field of high temperature solid oxide electrolysers, usually designated by the acronym SOEC (for “Solid Oxide Electrolysis Cell”).

It also relates to the field of high temperature Solid oxide fuel-cells, usually referred to by the acronym SOFC.

Thus, more generally, the invention refers to the field of stacks of solid oxide cells of the SOEC/SOFC type operating at high temperature.

More specifically, the invention relates to a system for conditioning a plurality of stacks of solid oxide cells of the SOEC/SOFC type operating at high temperature, allowing the simultaneous conditioning of the stacks.

### PRIOR ART

In the context of a high temperature solid oxide electrolyser of the SOEC type, it involves transforming, through an electric current, within the same electrochemical device, steam (H₂O) into dihydrogen (H₂) or other fuels such as methane (CH₄), natural gas, biogas, and dioxygen (O₂), and/or to transform carbon dioxide (CO₂) into carbon monoxide (CO) and dioxygen (O₂). In the context of a high temperature solid oxide fuel-cell of the SOFC type, the operation is reversed to produce an electric current and heat by being supplied with dihydrogen (H₂) and dioxygen (O₂), typically with air and natural gas, namely methane (CH₄). For the sake of simplicity, the following description favours the operation of a high temperature solid oxide electrolyser of the SOEC type carrying out the electrolysis of steam. However, this operation is applicable to the electrolysis of carbon dioxide (CO₂), or even the high temperature co-electrolysis of steam (HTE) with carbon dioxide (CO₂). Furthermore, this operation can be transposed to the case of a high temperature solid oxide fuel-cell of the SOFC type.

To carry out the electrolysis of water, it is advantageous to carry it out at high temperature, typically between 60° and 1000° C., because it is more advantageous to electrolyse steam than liquid water and because part of the energy necessary for the reaction can be provided by heat, cheaper than electricity.

To implement high temperature steam electrolysis (HTSE), a high temperature solid oxide electrolyser of the SOEC type is made up of a stack of elementary units each including a solid oxide electrolysis cell, or electrochemical cell, made up of three anode/electrolyte/cathode layers superimposed on each other, and interconnection plates made of metal alloys, also called bipolar plates or interconnectors. Each electrochemical cell is clamped between two interconnection plates. A high temperature solid oxide electrolyser of the SOEC type is then an alternating stack of electrochemical cells and interconnectors. A high temperature solid oxide fuel-cell of the SOFC type is made up of the same type of stack of elementary units. This high temperature technology being reversible, the same stack can operate in electrolysis mode and produce hydrogen and oxygen from water and electricity, or in fuel-cell mode and produce electricity from hydrogen and oxygen.

Each electrochemical cell corresponds to an electrolyte/electrode assembly, which is typically a multilayer ceramic assembly whose electrolyte is formed by a central ion-conducting layer, this layer being solid, dense and sealed, and clamped between the two porous layers forming the electrodes. It should be noted that additional layers may exist, but which only serve to improve one or more of the layers already described.

The interconnection devices, which are electrical and fluidic, are electronic conductors which ensure, from an electrical point of view, the connection of each electrochemical cell of elementary unit in the stack of elementary units, guaranteeing electrical contact between a face and the cathode of a cell and between the other face and the anode of the next cell, and from a fluidic point of view, the supply of reagents and the evacuation of products for each of the cells. The interconnectors thus provide the functions of supplying and collecting electrical current and delimit gas circulation compartments, for distribution and/or collection.

More specifically, the main function of the interconnectors is to ensure the passage of electric current but also the circulation of gases in the vicinity of each cell (namely: injected steam, hydrogen and oxygen extracted for HTE electrolysis; air and fuel including injected hydrogen and extracted steam for a SOFC), and to separate the anode and cathode compartments of two adjacent cells, which are the gas circulation compartments on the side respectively of the anodes and cathodes of the cells.

In particular, for a high temperature solid oxide electrolyser of the SOEC type, the cathode compartment includes steam and hydrogen, product of the electrochemical reaction, while the anode compartment includes a draining gas, if present, and oxygen, another product of the electrochemical reaction. For a high temperature solid oxide fuel-cell of the SOFC type, the anode compartment includes the fuel, while the cathode compartment includes the oxidant.

To carry out high temperature steam electrolysis (HTE), steam (H₂O) is injected into the cathode compartment. Under the effect of the electric current applied to the cell, the dissociation of water molecules in the form of vapour is carried out at the interface between the hydrogen electrode (cathode) and the electrolyte: this dissociation produces dihydrogen gas (H₂) and oxygen ions (O²⁻). The dihydrogen (H₂) is collected and evacuated at the outlet of the hydrogen compartment. Oxygen ions (O²⁻) migrate through the electrolyte and recombine into dioxygen (O₂) at the interface between the electrolyte and the oxygen electrode (anode). A draining gas, such as air, can circulate at the anode and thus collect the oxygen generated in gas form at the anode.

To ensure the operation of a solid oxide fuel-cell (SOFC), air (oxygen) is injected into the cathode compartment of the fuel-cell and hydrogen into the anode compartment. The oxygen in the air will dissociate into O²⁻ ions. These ions will migrate in the electrolyte from the cathode to the anode to oxidise the hydrogen and form water with a simultaneous production of electricity. In a SOFC, just like in SOEC electrolysis, the steam is found in the dihydrogen (H₂) compartment. Only the polarity is reversed.

By way of illustration, FIG. 1 shows a schematic view showing the operating principle of a high temperature solid oxide electrolyser of the SOEC type. The function of such an electrolyser is to transform steam into hydrogen and oxygen according to the following electrochemical reaction:

2H₂O→2H₂+O₂.

This reaction is carried out electrochemically in the cells of the electrolyser. As shown schematically in FIG. 1, each elementary electrolysis cell 1 is formed of a cathode 2 and an anode 4, placed on either side of a solid electrolyte 3. The two electrodes (cathode and anode) 2 and 4 are electronic and/or ionic conductors, made of porous material, and the electrolyte 3 is gas-tight, electronic insulator and ionic conductor. The electrolyte 3 can in particular be an anionic conductor, more precisely an anionic conductor of O²⁻ ions and the electrolyser is then called anionic electrolyser, as opposed to proton electrolytes (H⁺).

The electrochemical reactions take place at the interface between each of the electronic conductors and the ionic conductor.

At the cathode 2, the half-reaction is as follows:

2H₂O+4e⁻→2H₂+2O²⁻.

At the anode 4, the half-reaction is as follows:

2O^{2-→O}₂+4e⁻.

The electrolyte 3, interposed between the two electrodes 2 and 4, is the place of migration of the O²⁻ ions under the effect of the electric field created by the potential difference imposed between the anode 4 and the cathode 2.

As illustrated in parentheses in FIG. 1, the steam at the cathode inlet can be accompanied by hydrogen H₂ and the hydrogen produced and recovered at the outlet can be accompanied by steam. Likewise, as illustrated in dotted lines, a draining gas, such as air, can also be injected at the anode side inlet to evacuate the oxygen produced. The injection of a draining gas has the additional function of acting as a thermal regulator.

An elementary electrolyser, or electrolysis reactor, consists of an elementary cell as described above, with a cathode 2, an electrolyte 3, and an anode 4, and two interconnectors which provide the functions of electrical and fluid distribution.

To increase the flow rates of hydrogen and oxygen produced, it is known to stack several elementary electrolysis cells on top of each other, separating them by interconnectors. The assembly is positioned between two end interconnection plates which support the power supplies and gas supplies to the electrolyser (electrolysis reactor).

A high temperature solid oxide electrolyser of the SOEC type thus comprises at least one, generally a plurality of electrolysis cells stacked on top of each other, each elementary cell being formed of an electrolyte, a cathode and an anode, the electrolyte being interposed between the anode and the cathode.

As indicated previously, the fluidic and electrical interconnection devices which are in electrical contact with one or more electrodes generally provide the functions of supplying and collecting electric current and delimit one or more gas circulation compartments.

Thus, the function of the compartment called cathode compartment is the distribution of electric current and steam as well as the recovery of hydrogen at the cathode in contact.

The compartment called anode compartment has the function of distributing the electric current as well as recovering the oxygen produced at the anode in contact, possibly using a draining gas.

FIG. 2 shows an exploded view of elementary units of a high temperature solid oxide electrolyser of the SOEC type according to the prior art. This electrolyser includes a plurality of elementary electrolysis cells C1, C2, of the solid oxide cell (SOEC) type, stacked alternately with interconnectors 5. Each cell C1, C2 consists of a cathode 2.1, 2.2 and an anode (only the anode 4.2 of the cell C2 is shown), between which an electrolyte is disposed (only the electrolyte 3.2 of the cell C2 is shown).

The interconnector 5 is a metal alloy component which ensures the separation between the cathode 50 and the anode 51 compartments, defined by the volumes between the interconnector 5 and the adjacent cathode 2.1 and between the interconnector 5 and the adjacent anode 4.2 respectively. It also ensures the distribution of gases to the cells. The injection of steam into each elementary unit is done in the cathode compartment 50. The collection of the hydrogen produced and the residual steam at the cathode 2.1, 2.2 is carried out in the cathode compartment 50 downstream of the cell C1, C2 after dissociation of the steam by the latter. The collection of oxygen produced at the anode 4.2 is carried out in the anode compartment 51 downstream of the cell C1, C2 after dissociation of the steam by the latter. The interconnector 5 ensures the passage of current between the cells C1 and C2 by direct contact with the adjacent electrodes, that is to say between the anode 4.2 and the cathode 2.1.

The operating conditions of a high temperature solid oxide electrolyser (SOEC) being very close to those of a solid oxide fuel-cell (SOFC), the same technological constraints are found.

Thus, the proper operation of such stacks of solid oxide cells of the SOEC/SOFC type operating at high temperature mainly requires satisfying the points set out below.

First of all, it is necessary to have electrical insulation between two successive interconnectors otherwise the electrochemical cell will be short-circuited, but also good electrical contact and a sufficient contact surface between a cell and an interconnector. The lowest possible ohmic resistance is sought between cells and interconnectors.

Moreover, it is necessary to have a sealing between the anode and cathode compartments otherwise there will be a recombination of the gases produced leading to a drop in efficiency and especially the appearance of hot spots damaging the stack.

Finally, it is essential to have good distribution of gases both at the inlet and at the recovery of the products, otherwise there will be loss of yield, inhomogeneity of pressure and temperature within the different elementary units, or even crippling degradation of the electrochemical cells.

The incoming and outgoing gases in a high temperature electrolysis stack (SOEC) or fuel-cell (SOFC) operating at high temperature can be managed by means of devices such as that illustrated with reference to FIG. 3. The device 10 thus includes cold parts PF and hot parts PC, the latter comprising the oven 11 base, a loop tube 12 to manage the gas inlets and outlets and the high temperature electrolysis stack 20 (SOEC) or fuel-cell (SOFC).

Moreover, FIG. 4 illustrates an example of an assembly 80 comprising such a stack 20 and a clamping system 60 thereof. Such an assembly 80 can be as described in French patent application FR 3 045 215 A1.

Thus, the stack 20 includes a plurality of electrochemical cells 41 each formed of a cathode, an anode and an electrolyte interposed between the cathode and the anode, and a plurality of intermediate interconnectors 42 each arranged between two adjacent electrochemical cells 41. In addition, it includes an upper end plate 43 and a lower end plate 44, respectively also called upper stack end plate 43 and lower stack end plate 44, between which the plurality of electrochemical cells 41 and the plurality of intermediate interconnectors 42 are clamped, or between which the stack is located.

The clamping system 60 includes an upper clamping plate 45 and a lower clamping plate 46, between which the stack 20 is clamped. Each clamping plate 45, 46 includes four clamping orifices 54 through which clamping stems 55, or tie rods, extend. Clamping means 56, 57, 58 are provided at the ends of said stems.

In general, to date, the stacks 20 have a limited number of electrochemical cells 41.

Before its operation, it is necessary to subject the stack 20 to at least one heat treatment step called reduction heat treatment step, in order to put the electrochemical cells 41 in their reduced form, and not oxidised as they are initially. This reduction step can be a thermomechanical cycle under reducing gas for the hydrogen electrode and air or neutral gas for the oxygen electrode. Such a heat treatment step has for example been described in European patent application EP 2 870 650 A1.

Moreover, the stacks 20 implemented to date generally use, at each of their stages, joints which must guarantee sealing between two adjacent and distinct gas circulation compartments that is to say an anode compartment and a cathode compartment. Such joints have been described in European patent application EP 3 078 071 A1. These joints have the particularity of requiring thermal conditioning during which they crush, settle into place and change microstructure.

In addition, the contact elements, such as the layers described in patent application EP 2 900 846 A1 or the Nickel grids, also crush during thermal conditioning and during operation of the stack 20, which guarantees their proper implementation. The elements which serve as contact elements in the hydrogen chamber are also crushed.

In other words, during the thermal conditioning step, a stack 20 is crushed by several centimetres. To date, given the relatively small number of stacked cells, the crushing is proceeding correctly.

However, the Applicant has considered making stacks with a larger number of electrochemical cells. In this case, the expected movement when clamping the stack can lead to mechanical blocking problems of the bracing type on the guide stems. These blockages prevent good transfer of clamping forces and therefore good thermal conditioning, and consequently normal operation of the stack.

A solution to these disadvantages is to provide a stack concept wherein several sub-stacks are assembled, by means of stiffening plates, so as to manage large crushing. However, it is then necessary to condition each sub-stack separately and thus a large number of stacks and sub-stacks must be produced.

However, conditioning such a stack is a long and costly step because heating requires energy. In addition, current devices allow to condition a single stack or sub-stack at a time.

Consequently, there is still a need to improve the principle of conditioning high temperature electrolysis stacks (SOEC) or fuel-cells (SOFC), in particular to condition several stacks at the same time.

### DESCRIPTION OF THE INVENTION

The invention aims at least at partially addressing the needs mentioned above and the disadvantages relating to the embodiments of the prior art.

It aims in particular at achieving a multiple conditioning design for high temperature electrolysis stack (SOEC) or fuel-cell stack (SOFC) while maintaining controlled clamping despite the large crush stroke of the stacks.

The invention thus has, according to one of its aspects, a system for conditioning a plurality of stacks of solid oxide cells of the SOEC/SOFC type operating at high temperature,
each stack including a plurality of electrochemical cells each formed of a cathode, an anode and an electrolyte interposed between the cathode and the anode, and a plurality of intermediate interconnectors each arranged between two adjacent electrochemical cells, characterised in that the system includes:
   a thermal enclosure delimiting an internal volume,
   a plurality of stacks placed in the internal volume,
   a frame, positioned on either side of the thermal enclosure,
   a first crosspiece device, mounted on the frame in a movable manner relative thereto, superimposed on the thermal enclosure,
   a plurality of clamping rods, each stack being associated with one or more clamping rods, the clamping rods being mounted through the first crosspiece device and intended to contact the stacks to allow them to be clamped,
   a plurality of elastic return members, each stack being associated with one or more elastic return members, each elastic return member being mounted around a clamping rod and fixed, by a first end, to the clamping rod by means of a fixing element as well as, by a second end, to the first crosspiece device by means of a guiding and holding element, so that the clamping rod is supported by the elastic return member capable of being compressed under the effect of the weight of the clamping rod.

The conditioning system according to the invention may further include one or more of the following features taken individually or in any possible technical combination.

The number of stacks can be comprised between 2 and 100. Preferably, the number of stacks can be equal to 4, in particular disposed in two rows of two, so as to allow good balancing of the first crosspiece device which can be in the shape of a cross.

In addition, the conditioning system according to the invention may include a base, placed in the internal volume of the thermal enclosure and on which the plurality of stacks is placed.

Each stack can be associated with a number of elastic return members comprised between 1 and 10, each stack being in particular associated with a single and unique elastic return member and a single and unique clamping rod. Note that it is also possible to have several clamping rods on each stack. The advantage would be to reduce the force provided by each cane and by each elastic return member. The alignment of the clamping is then facilitated.

Preferably, the stacks can be positioned on the same plane. In other words, the stacks can be placed next to each other, and advantageously not be superimposed on top of each other.

Furthermore, the rigidity of each elastic return member can be comprised between 0.1 N/mm and 1000 N/mm, in particular between 1 N/mm and 20 N/mm.

The length of each elastic return member can be comprised between 0.1 m and 10 m, in particular between 1 m and 2 m.

The number of electrochemical cells may preferably be greater than or equal to 25. However, the invention also applies to a number of electrochemical cells less than 25.

Moreover, the conditioning system according to the invention may include at least one support for the stacks, in particular one support per stack, secured to the frame, in particular formed through a base on which the plurality of stacks is placed.

Furthermore, the invention also relates, according to another of its aspects, to a method for clamping a plurality of stacks of solid oxide cells of the SOEC/SOFC type operating at high temperature by means of a conditioning system as defined above, characterised in that it includes the step consisting of moving the first crosspiece device relative to the frame in the direction of the plurality of stacks.

The method can advantageously be implemented under inert gas.

### BRIEF DESCRIPTION OF THE DRAWINGS

The invention can be better understood upon reading the detailed description which follows, non-limiting examples of its implementation, as well as upon examining the schematic and partial figures of the appended drawing, on which:

FIG. 1 is a schematic view showing the operating principle of a high temperature solid oxide electrolyser (SOEC),

FIG. 2 is an exploded schematic view of a part of a high temperature solid oxide electrolyser (SOEC) comprising interconnectors according to the prior art,

FIG. 3 illustrates the principle of the architecture of a furnace on which a high temperature electrolysis (SOEC) or fuel-cell (SOFC) stack operating at high temperature is placed,

FIG. 4 shows, in perspective and by observation from above, an example of a stack of solid oxide cells of the SOEC/SOFC type according to the prior art with a self-clamping system for the stack,

FIG. 5 shows, schematically in section, an example of a conditioning system according to the invention of a plurality of stacks of solid oxide cells of the SOEC/SOFC type operating at high temperature, in an empty position without clamping,

FIG. 6 shows, schematically in section, the example of the conditioning system of [FIG. 5] in a simple contact position of the clamping rods against the stacks 20 without clamping,

FIG. 7 shows, schematically in section, the example of the conditioning system of [FIG. 5] in a contact position with clamping, and

FIG. 8 shows, schematically and in section, an alternative embodiment of the conditioning system of [FIG. 5] according to a view similar to that of [FIG. 7].

In all of these figures, identical references can designate identical or similar elements.

In addition, the different parts shown in the figures are not necessarily on a uniform scale, to make the figures more readable.

### DETAILED DESCRIPTION OF PARTICULAR EMBODIMENTS

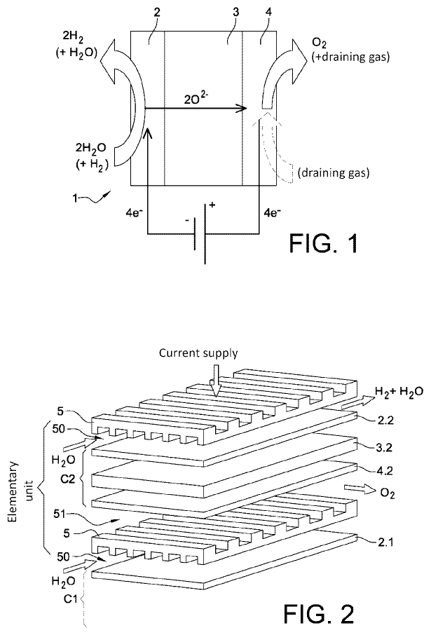

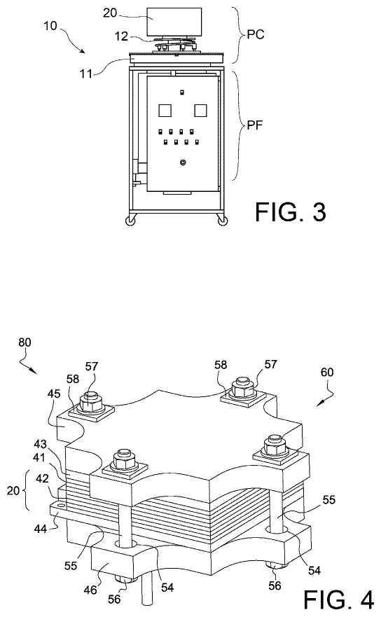

FIGS. 1 to 4 have already been described previously in the section relating to the prior art and the technical context of the invention. It is specified that, for FIGS. 1 and 2, the symbols and arrows for supply of steam H2O, distribution and recovery of dihydrogen H2, oxygen O2, air and electric current, are shown for purposes of clarity and precision, to illustrate the operation of the devices shown.

Furthermore, it should be noted that all the constituents (anode/electrolyte/cathode) of a given electrochemical cell are preferably ceramics. The operating temperature of a high temperature SOEC/SOFC type stack is also typically comprised between 60° and 1000° C.

In addition, the possible terms “upper” and “lower” are to be understood here according to the normal direction of orientation of a SOEC/SOFC type stack when in its use configuration.

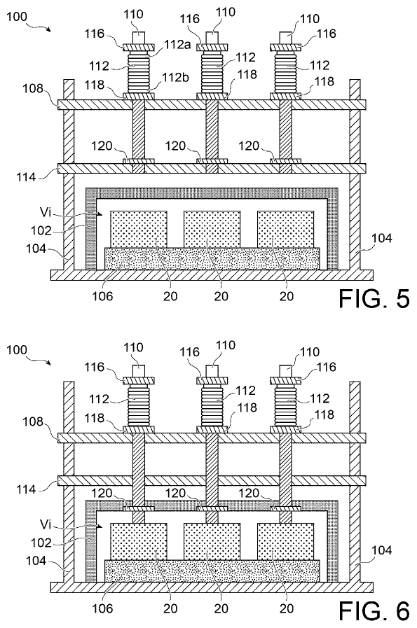

An example of a conditioning system 100 in accordance with the invention of several stacks 20 of the SOEC/SOFC type will now be described with reference to FIGS. 5 to 7 relating to the same embodiment shown in different views. A variant will be described with reference to FIG. 8.

The conditioning of 3 stacks 20 is considered here. However, the number of stacks 20 can be much greater, in particular comprised between 2 and 100. In particular, there can be 4 stacks 20 disposed in two rows of two so as to have good balancing of the first crosspiece device 108, then advantageously in the shape of a cross. Advantageously, the stacks 20 are disposed in the same plane, next to each other, and therefore are not superimposed on each other.

In FIG. 5, the conditioning system 100 in accordance with the invention is shown while no clamping, nor any contact, takes place at the three stacks 20.

As described previously in the part relating to the prior art and the technical context of the invention, each stack 20 includes a plurality of electrochemical cells 41 each formed of a cathode, an anode and an electrolyte interposed between the cathode and the anode, and a plurality of intermediate interconnectors 42 each arranged between two adjacent electrochemical cells 41.

The three stacks 20 are placed in the internal volume Vi of a thermal enclosure 102 of the conditioning system 100. In addition, a frame 104 is positioned on either side of the thermal enclosure 102, this frame 104 allowing to take up mechanical forces.

On this frame 104 is mounted a first crosspiece device 108, movable relative to the frame 104, being for example sliding. This first crosspiece device 108 is located superimposed on the thermal enclosure 102, above the latter in FIG. 5.

Moreover, three clamping rods 110, one for each stack 20, are mounted through the first crosspiece device 108, for example by means of orifices formed thereon. These three clamping rods 110 allow the clamping of the three stacks 20.

The thermal enclosure 102 comprises openings larger than the clamping rods 110. A little insulating wool is positioned thereon to limit heat loss but remaining flexible so as not to hinder movement.

In addition, advantageously, three springs 112 are used, one spring 112 for each stack 20. Each spring 112 is mounted around its corresponding clamping rod 110. The spring 112 is then fixed, by its first end 112a, to the clamping rod 110 by means of a fixing element 116 as well as, by its second end 112b, to the first crosspiece device 108 by means of a guiding and holding element 118. In other words, in this raised position of the first crosspiece device 108 visible in FIG. 5, the clamping rods 110 rest on the springs 112. Indeed, each spring 112 is fixed to the corresponding clamping rod 110 by means of the fixing element 116, and the guiding and holding element 118 allows the guiding of the clamping rod 110 and the holding of the spring 112 against the first crosspiece device 108. Thus, the clamping rod 110 is supported by the spring 112, which is in compression due to the weight of the clamping rod 110.

It should be noted that the rigidity of each spring 112 is comprised between 0.1 N/mm and 1000 N/mm, and preferably between 1 N/mm and 20 N/mm. In addition, the length of each spring 112 is comprised between 0.1 m and 10 m, and preferably between 1 m and 2 m.

Advantageously, the choice of the stiffness/length couple of each spring 112 can be made in such a way that a crushing or loosening of a few tens of millimetres only results in an impact of a few percentages on the nominal clamping. A large spring 112 of great length, for example 1.5 m, and of low stiffness allows to easily apply a force of several kN with good precision, even if the object on which the forces are applied undergoes significant variations in size.

For example, a stack 20, or sub-stack, of 25 cells and 200 cm² must be clamped to 4000 N. Its crushing stroke during conditioning is of the order of 35 mm. Thus, with a spring 112 of 1.5 m and a stiffness of 6 N/mm, it is sufficient to crush the spring 112 of 800 mm to obtain a clamping of 4 kN. When the stack 20 is crushed during its conditioning, the reduction in clamping will be 210 N, or around 5% variation in force compared to the setpoint.

The problems of expansion of tie rods or clamping rods 110 can also be solved since the expansion of a metal rod with an expansion coefficient of 12.10-6/° C. and 1500 mm, which goes from 20° C. to 850° C., has an expansion of 1500×830×1.2×10-5=15 mm. This variation results in an overload of 90 N.

In this FIG. 5, it is also seen that the conditioning system 100 includes a second crosspiece device 114, mounted in a fixed manner relative to the frame 104, so as to improve its rigidity, and traversed by the clamping rods 110. Moreover, three free guide elements 120 are present, in particular at this second crosspiece device 114.

The free guide elements 120 may be metal workpieces including a central circular recess whose diameter is adjusted to that of the clamping rod 110. This recess is adjusted so that its diameter is very slightly greater than that of the clamping rod 110. In addition, the guide has a certain height to guide well.

Such an element is important because it is important to apply the force right to the centre of the object. The guiding allows the clamping rod to be properly centred in the middle of the stack to be conditioned.

Furthermore, the three stacks 20 are positioned on a base 106, or else a manifold 106, to allow gas exchanges. No load then applies to the stacks 20 in this representation of FIG. 5.

Advantageously, the invention then allows to impose a common movement on all the springs 112, thanks to the first crosspiece device 108 applying the same movement to all the springs 112. Advantageously again, the use of a single independent spring 112 per stack 20, in cold areas, allows clamping to be controlled. The use of springs of great length and low rigidity can allow to apply practically constant clamping even in the event of significant variation in the position of the object to be clamped.

The movement of the first crosspiece device 108 relative to the frame 104 towards the plurality of stacks 20 allows to obtain the desired clamping. This conditioning can be carried out under inert gas but it is also possible to use other types of gas.

More specifically, if there is a manifold capable of distributing gases inside each stack 20, then it is possible to place the internal volume Vi under air or under inert gas. On the other hand, if there is no manifold capable of distributing gases inside the stacks 20, it is then necessary to inert the internal volume Vi with an inert gas.

In FIG. 6, the clamping rods 110 are in contact with the stacks 20 but no clamping is carried out. For this purpose, the first crosspiece device 108 was lowered until it made contact with the first stack 20.

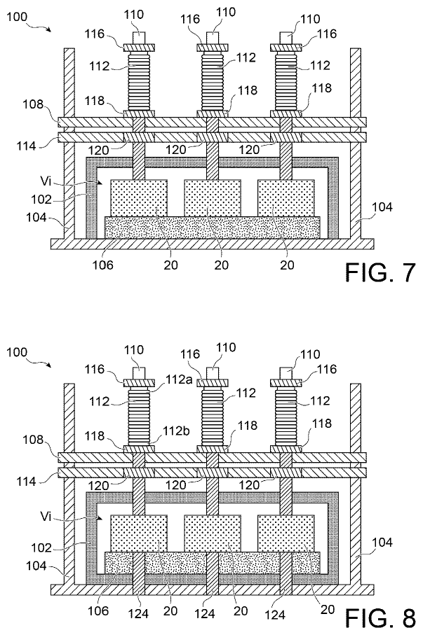

To be able to clamp the stacks 20, as shown in FIG. 7, the first crosspiece device 108 is moved downwards by a given movement to obtain the desired clamping. Clamping is done in imposed movement related to the rigidity of the springs 112. Thus, a spring 112 of 6 N/mm will be compressed by 800 mm to apply a force of 4000 N.

When contact is established, the spring 112 extends and under the effect of this elongation, a force is applied to the stack 20 which is proportional to the movement of the first crosspiece device 108.

This clamping principle in accordance with the invention has multiple advantages. For example, if a stack 20 is 1 mm higher than another, then the over-clamping undergone by stack 20 will be 6 N, which is negligible given the 4000 N imposed. Likewise, if a stack 20, when conditioned, is crushed more than another by 1 mm, then it will undergo an unloading of 6 N, which is negligible given the 4000 N imposed.

Moreover, the thermal expansions of a clamping rod 110 of the order of 15 mm overload the stack 20 by 90 N, which is also negligible given the 4000 N imposed, as well as the 35 mm of crushing, which occur during conditioning, which create an unloading of around 210 N. Also, the expansions partly compensate for the crushing.

To minimise the impact of lateral thermal expansions and the problem of centring the clamping rods 110 relative to the stacks 20, a support or foot 124 can be provided in the internal volume Vi of the thermal enclosure 102, as shown in the variant embodiment of FIG. 8.

The positioning of the guiding is an important point and depending on its position the guiding can be more or less good, in particular regarding thermal expansion. The example in FIG. 8 is advantageous in so far as the guiding is integral with the crosspiece 114 connected to the frame 104 and the foot 124. Thus, when the overall system heats up, everything will expand together and the point of support will remain in the centre of the object.

In particular, in this example, each stack 20 is supported by a support 124 formed through the manifold 106. Each support 124 is advantageously connected, secured, to the frame 104 which is located in the cold area. Thus, the complete mechanical frame 104 is in the cold area, as well as the guiding of the clamping rods 110.

Generally and in a manner applicable to any embodiment of the invention, the positioning of the frame 104 in a cold area is advantageous. Indeed, if the frame 104 is in a hot area, then the resistance of the materials decreases drastically and to take up the forces, it is then necessary to have a frame 104 with much more expensive materials and a more robust dimension, for example a beam which takes up the forces at least twice as high. Moreover, if all the elements, frame 104, crosspiece 114 and elastic return member, are in a cold area, then there is no problem centring the workpieces with respect to expansions, everything remaining well aligned.

Of course, the invention is not limited to the embodiments which have just been described. Various modifications can be made thereto by the person skilled in the art.

In particular, it should be noted that it is possible to subject the entire oven to an inert gas and to work without the presence of a manifold 106. Then, the oven includes a sealed internal muffle and the junction between clamping rod 110 and muffle is made by a bellows.

1. A system for conditioning a plurality of stacks of solid oxide cells of the SOEC/SOFC type operating at high temperature, each stack including a plurality of electrochemical cells each formed of a cathode, an anode and an electrolyte interposed between the cathode and the anode, and a plurality of intermediate interconnectors each arranged between two adjacent electrochemical cells, the system comprising:
a thermal enclosure delimiting an internal volume,
a plurality of stacks placed in the internal volume,
a frame, positioned on either side of the thermal enclosure,
a first crosspiece device, mounted on the frame in a movable manner relative thereto, superimposed on the thermal enclosure,
a plurality of clamping rods, each stack being associated with one or more clamping rods, the clamping rods being mounted through the first crosspiece device and intended to contact the stacks to allow them to be clamped,
a plurality of elastic return members, each stack being associated with one or more elastic return members, each elastic return member being mounted around a clamping rod and fixed, by a first end, to the clamping rod by means of a fixing element as well as, by a second end, to the first crosspiece device by means of a guiding and holding element, so that the clamping rod is supported by the elastic return member capable of being compressed under the effect of the weight of the clamping rod,
wherein each stack is associated with a number of elastic return members comprised between 1 and 10.

2. The system according to claim 1, wherein the number of stacks is comprised between 2 and 100.

3. The system according to claim 1, further comprising a base, placed in the internal volume of the thermal enclosure and on which the plurality of stacks is placed.

4. The system according to claim 1, wherein each stack is associated with a single and unique elastic return member and a single and unique clamping rod.

5. The system according to claim 1, wherein the rigidity of each elastic return member is comprised between 0.1 N/mm and 1000 N/mm, in particular between 1 N/mm and 20 N/mm.

6. The system according to claim 1, wherein the length of each elastic return member is comprised between 0.1 m and 10 m, in particular between 1 m and 2 m.

7. The system according to claim 1, further comprising at least one support for the stacks, in particular one support per stack, secured to the frame, in particular formed through a base on which the plurality of stacks is placed.

8. A method for clamping a plurality of stacks of solid oxide cells of the SOEC/SOFC type operating at high temperature by means of a conditioning system according to claim 1, the method comprising moving the first crosspiece device relative to the frame in the direction of the plurality of stacks.

9. The method according to claim 8, wherein the method is implemented under inert gas.
